(19) United States
(12) Patent Application Publication
(10) Pub. No.: US 2011/0067648 A1
(43) Pub. Date: Mar. 24, 2011

(54) PET HARNESS SAFETY SYSTEM

(75) Inventors: Tibor Siklosi, Grove, OK (US); David Price, Miami, OK (US)

(73) Assignee: BERGAN, LLC, Monkey Island, OK (US)

(21) Appl. No.: 12/885,700

(22) Filed: Sep. 20, 2010

Related U.S. Application Data
(60) Provisional application No. 61/244,725, filed on Sep. 22, 2009.

(51) Int. Cl. A01K 27/00

(52) U.S. Cl. 119/792; 119/863

(57) ABSTRACT

A pet harness safety system has a harness assembly with two parallel body loops and a carabiner tether assembly with opposing carabiners. During usage, one of the carabiners is secured to a reinforced loop on each of the body loops of the harness assembly and the other carabiner is secured to an in-vehicle restraint system. The body loops are substantially parallel to the body of the dog such that only its shoulders are encircled by the body loops, and are adjustably joined together to form a completed or closed system.

### CROSS-REFERENCE TO RELATED APPLICATIONS

This application claims priority to U.S. Provisional Application Ser. No. 61/244,725 filed Sep. 22, 2009, which is incorporated herein by reference.

### BACKGROUND OF THE INVENTION

1. Field of the Invention

This invention relates generally to a pet harness safety system, and more particularly to a pet harness safety system having a harness assembly worn by a pet and a carabiner tether assembly to secure the harness assembly to a vehicle during usage.

2. Description of the Related Art

Pet safety systems are essential when traveling with a pet, such as a dog, to protect the pet and the driver and any passengers in a vehicle. Pet safety systems are available in a variety of sizes and styles, and few crash tests have been conducted to ensure they will do the job in case of a sudden stop or accident. Statistically, a twenty-five (25) pound, unrestrained dog can become a deadly, one-thousand (1000) pound projectile in the event of a forty (40) mph vehicular crash. In addition, pet safety systems prohibit the pet from distracting the driver while driving the vehicle, making travel safer for everyone.

Current pet safety systems, however, do not meet any reasonable safety standards. Many harnesses of the current pet safety systems are designed for walking and built to meet the form, fit, and function of walking the dog and effectively put a “safety” claim on a walking harness. Few harnesses of the current pet safety systems adequately provide for the safety of the pet (and their owners) when driving and potential hazards are encountered. For example, many of the existing harnesses for pet safety systems are not practical because they are either “over-engineered” and expensive or “under-engineered” and unsafe. Over-engineered harnesses for pet safety systems often include heavy, cumbersome buckles, hardware, and excessive webbing, and suffer from poor overall installation, design, and functionality. These over-engineered harnesses provide adequate safety by some expectations, but are impractical because they are difficult installation into the vehicle, difficult to fit properly to the pet, and/or have cumbersome buckles (e.g., car seat buckles on the harness), which are heavy, awkward, and clearly uncomfortable for the pet. In addition, these over-engineered harnesses render the pet safety system impractical for anything other than in-vehicle use. At the other extreme are the under-engineered harnesses, which are typically merely a walking harness labeled as a “safety harness” by only providing a means to secure or tether the pet in the vehicle. However, the under-engineered harness serves no practical safeguard in the event of an accident. The under-engineered harnesses fail at three-hundred (300) pounds of force, whereas a reasonable safety rating for an average pet would easily be five (5) to ten (10) times that force.

It is therefore desirable to provide a pet harness safety system that limits all unnecessary hardware, connectors, and buckles by providing a harness assembly that includes two support body loops made from webbing that are joined by a carabiner tether assembly, which becomes a part of the pet harness safety system without disrupting/interrupting the integrity of the body loops.

It is still further desirable to provide a pet harness safety system having a carabiner tether assembly designed to “close” the pet harness safety system and secure the harness assembly to the vehicle.

It is yet further desirable to provide a pet harness safety system that is light-weight and capable of being easily worn either in or out of the vehicle, while exceeding the safety ratings for the appropriate dog weights by withstanding over four-thousand (4,000) pounds of force.

It is yet further desirable to provide a pet harness safety system that may be easily put on or taken off of a pet while keeping a consistent custom fit.

### SUMMARY OF THE INVENTION

In general, the invention relates to a pet harness safety system having a harness assembly and a carabiner tether assembly. The carabiner tether assembly includes an elongate tether body with opposing carabiners. During usage, one of the carabiners is secured to the harness assembly while the other carabiner is secured to the seat belt buckle webbing or child seat latch. The harness assembly includes two parallel body loops that are adjustably joined together via a body support to form a completed or closed system without any additional hardware, connectors or metal rings. Each of the body loops are folded to form a reinforced loop at a point of attachment to the carabiner and a slide to adjust the size and fit the body loops about the dog and close the loop system. The chest plate body support includes a series of body loop apertures for receipt of the body loops.

A primary and a secondary back plate are respectively attached to the body loops and may be releasably fastened together using a fitting connector. The primary back plate is movable between an open position and a closed potion. The fitting connector does not interrupt or interfere with the integrity of the pet harness safety system and does not bear any load when a load is placed on the pet harness safety system, such as during an accident involving the vehicle.

During use, the pet harness safety system loops substantially parallel to the body of the dog such that only its shoulders are encircled by the body loops, at which point they may be releasably coupled via the fitting connector. The primary back plate is moved from the open to the closed position, the loops of the body loops are secured by the carabiner, and the carabiner can be secured thereto to secure the pet harness safety system to the vehicle.

### BRIEF DESCRIPTION OF THE DRAWINGS

FIG. 1 is a perspective view of an illustrative embodiment of the pet harness safety system disclosed herein;

FIG. 2 is an exterior view of the illustrative embodiment of the pet harness safety system shown in FIG. 1;

FIG. 3 is an interior view of the illustrative embodiment of the pet harness safety system shown in FIG. 1;

FIG. 4 is an exploded view of an example of a primary back plate in an open position in accordance with an illustrative embodiment of the pet harness safety system disclosed herein; and

FIG. 5 is an exploded view of the primary back plate of the pet harness safety system shown in FIG. 4 in a closed position.

Other advantages and features will be apparent from the following description, and from the claims.

### DETAILED DESCRIPTION OF THE INVENTION

The devices discussed herein are merely illustrative of specific manners in which to make and use this invention and are not to be interpreted as limiting in scope.

While the devices have been described with a certain degree of particularity, it is to be noted that many modifications may be made in the construction and the arrangement of the structural and functional details disclosed herein without departing from the spirit and scope of this disclosure. It is understood that the devices are not limited to the embodiments set forth herein for purposes of exemplification.

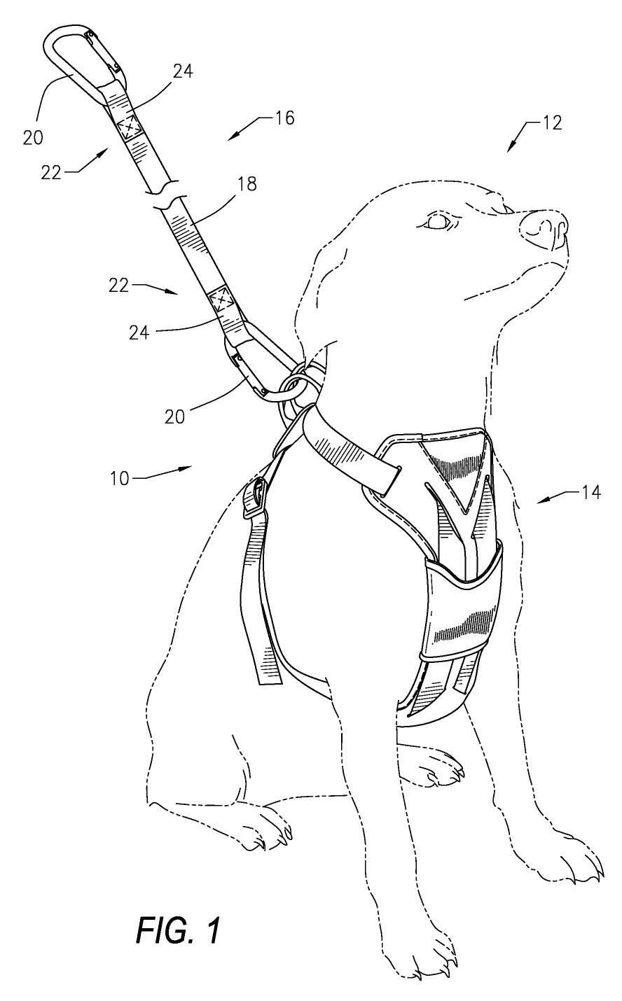

Referring to the figures of the drawings, wherein like numerals of reference designate like elements throughout the several views, and initially to FIG. 1, a pet harness safety system 10 is shown during use to secure to a dog 12 within a vehicle (not shown) for travel. The pet harness safety system 10 includes a harness assembly 14 and a carabiner tether assembly 16. As shown, the carabiner tether assembly 16 includes an elongate tether body 18 formed from suitable webbing and being disposed intermediate of opposing carabiners 20 on opposing terminal ends 22 of the tether body 18. Each opposing terminal end 22 may include a connection loop 24 formed by a length of the webbing secured to the tether body 18, and each of the connection loops 24 has the carabiner 20 received therethrough, as illustrated in FIG. 1. During usage, one of the carabiners 20 of the carabiner tether assembly 16 is secured to the harness assembly 14 while the other carabiner 20 is secured to the in-vehicle restraint system, such as by securing to the webbing of a seat belt latch (not shown).

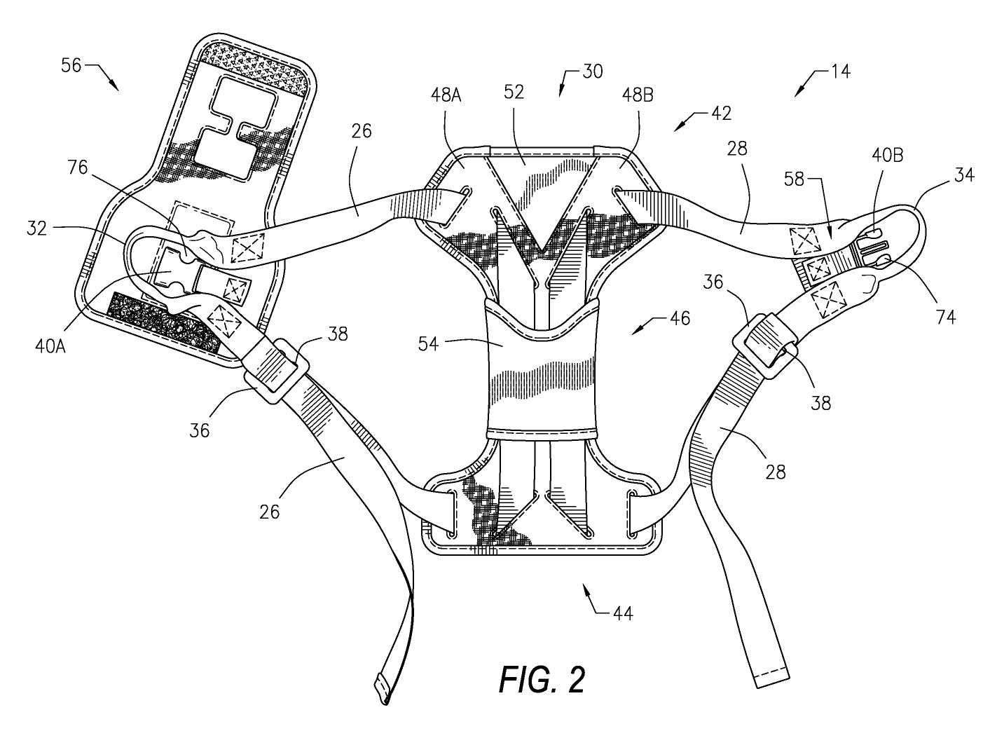

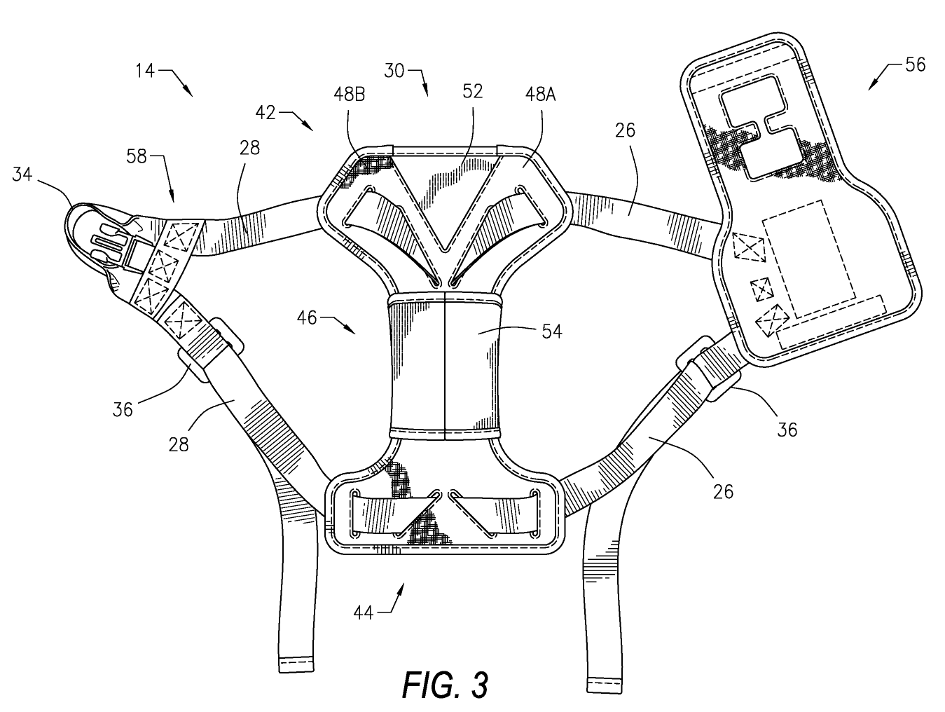

Referring now to FIGS. 2 and 3, the harness assembly 14 of the pet harness safety system 10 includes two parallel body loops 26 and 28 formed from suitable webbing, which are adjustably joined together via a body support 30 to form a completed or closed system without any additional hardware, connectors or metal rings. Each of the body loops 26 and 28 includes a reinforced segment that is secured to form a loop 32 and 34, respectively. Each of the body loops 26 and 28 also includes a slide 36, which may be adjusted to fit the body loops 26 and 28 of the pet harness safety system 10 to the dog 12. Each of the slides 36 includes a pair of parallel, elongate apertures 38 for receipt of the body loop 26 and 28. The slides 36 may be constructed of any light-weight metal or other suitable resilient material. The slides 36 enable the pet harness safety system 10 to be adjusted and fitted to the dog 12 once, and, thereafter, the pet harness safety system 10 can be easily put on and/or off with a fitting connector 40.

The body support 30, as exemplified in FIGS. 2 and 3, includes an upper section 42, a lower section 44, and an intermediate section 46 joining the upper section 42 and the lower section 44. The upper section 42 of the body support 30 may include opposing flared members 48A and 48B, each having a series of body loop apertures 50 for receipt of the respective body loops 26 or 28. The opposing flared members 48A and 48B of the upper section 42 of the body support 30 may be joined using a suitable webbing joint 52, and, as illustrated, a substantially V-shaped webbing joint 52 secured intermediate of the opposing flared members 48A and 48B. The lower section 44 may have a width greater than a width of the elongate intermediate section 46 and have a series of body loop apertures 50 for receipt of the respective body loops 26 and 28. Thus, the body support 30 may be substantially Y-shaped at the upper section 42 and substantially I-shaped at the lower section 44. In addition, a substantially tubular wrap 54 may surround the elongate intermediate section 46 and the segments of the body loops 26 and 28 engaged with the body support 30.

The reinforced loop 32 of the body loop 26 is secured to a primary back plate 56 loop, and the reinforced loop of the body loop 28 is secured to a secondary back plate 58. The primary back plate 56 includes a first segment 60 and a second segment 62, with the first segment 60 having a width less than a width of the second segment 62. On a face of the primary back plate 56, both the first segment 60 and the second segment 62 include a fastener, such as hook and loop fastener components 64A and 64B respectively placed such that the first segment 60 may be releasably fastened to the second segment 62. In addition, the first segment 60 includes a substantially I-shaped aperture 66 having opposing enlarged ends 68A and 68B separated by opposing projections 70A and 70B. The second segment 62 may include a reinforced portion 72 that abuts the fitting connector 40 during operation. The second segment 62 of the primary back plate 56 has a component 40A (shown as the female component) of the fitting connector 40 secured thereto, such as by using a length of webbing. The secondary back plate 58 secured to body loop 28 includes a component 40B (shown as the male component) of the fitting connector 40 secured thereto, such as also by using a length of webbing. The fitting connector 40 may be constructed of plastic or other resilient material and enables the pet harness safety system 10 to be easily and quickly put on and taken off the dog 12. The fitting connector 40 does not interrupt or interfere with the integrity of the pet harness safety system 10 and does not bear any load when a load is placed on the pet harness safety system 10, such as during an accident involving the vehicle.

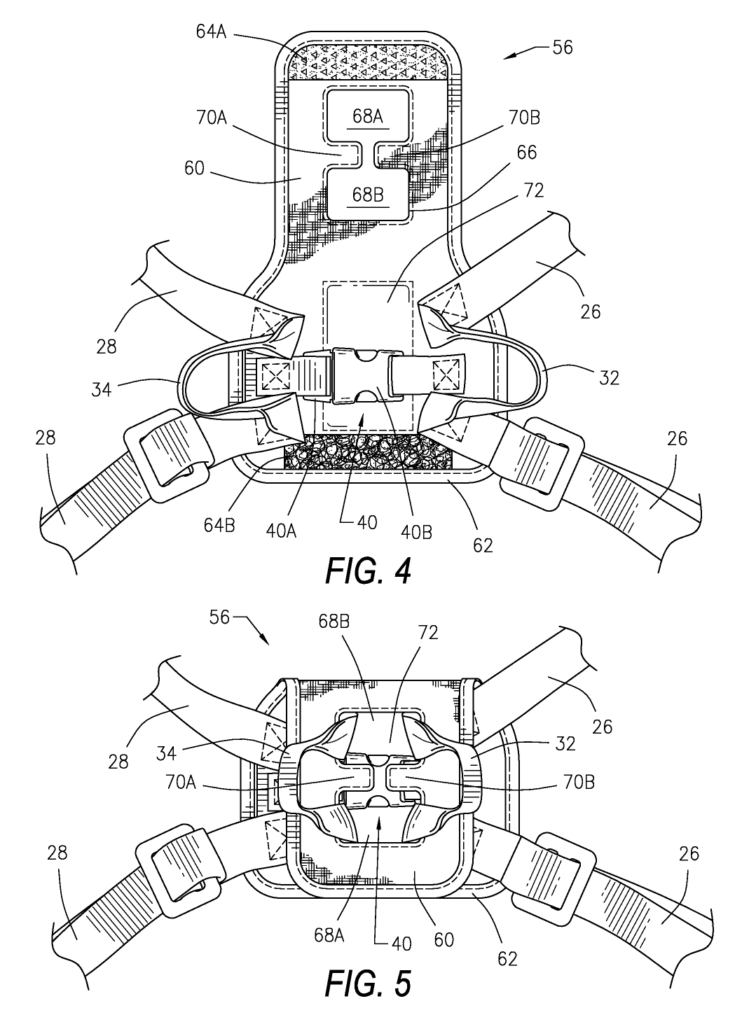

During use, an upper portion of the body loops 26 and 28 are positioned along the upper chest of the dog 12, while a lower portion of the body loops 26 and 28 are positioned along the lower chest of the dog 12, with the intermediate section of the body support 30 positioned substantially parallel to the sternum of the dog 12. Thus, the pet harness safety system 10 loops substantially parallel to the body of the dog 12, such that only the shoulders of the dog 12 are encircled by the body loops 26 and 28. The body loop 26 may be releasably coupled to the body loop 28 by inserting the male component 40B of the fitting connector 40 having opposing protruding detents 74 into the female component 40A of the fitting connector 40 (or vice versa), wherein the detents 74 engage detent openings 76 in the female connector 40A to releasably couple the body loop 26 to the body loop 28, as shown and illustrated in FIG. 4. The pet harness safety system may then be adjusted and fitted to the dog 12 using the slides 63 engaging the body loops 26 and 28.

FIG. 4 is an enlarged view of the primary back plate 56 in an open position, and FIG. 5 showing an enlarged view of the primary back plate 56 in a closed position. From the open position, the first segment 60 of the primary back plate 56 may be folded over the second segment 62 and the hook and loop fastener components 64A and 64B thereon may be releasably secured in the closed position. The loop 32 of the body loop 26 and the loop 34 of the body loop 28 are fed through the substantially I-shaped aperture 66 of the first segment 60 of the primary back plate 56, at which point the carabiner 20 of the carabiner tether assembly 16 is secured to the loops 32 and 34 of the body loops 26 and 28 to secure the pet harness safety system 10 to the vehicle. The pet harness safety system 10 is designed to utilize the carabiner tether assembly 16 and not a standard pet leash, since usage of a standard pet leash would effectively render the pet harness safety system 10 only as strong as the pet leash.

It will be appreciated that the pet harness safety system 10 may be constructed in varying sizes, such as small, medium, and large or based on a predetermined weight range. Once the pet harness safety system 10 is fitted and adjusted to the dog 12, it may be easily worn by the dog 12 both in and/or out of the vehicle.

The key features of the pet harness safety system 10 are (1) the harness loops around the pet's shoulders, minimizing the possibility of strangulation; (2) the fit connector is effectively outside the load bearing system allowing the harness to be custom fit one time, by the load bearing slide buckle, but installed on and off the pet conveniently with the fit buckle; and (3) continuous loops are parallel but jointed at the loop carabiner to form an uninterrupted system. Furthermore, the carabiner tether assembly may be attached and detached from the in-vehicle restraint system without interrupting the harness loop assembly. Thus, the harness loop assembly is for fitting the harness around the dog comfortably, while the carabiner tether assembly effectively connects the system together and to the vehicle.

Whereas, the devices have been described in relation to the drawings and claims, it should be understood that other and further modifications, apart from those shown or suggested herein, may be made within the spirit and scope of this invention.

What is claimed is:

1. A pet harness safety system for use on an animal with a chest, a back, and at least two shoulders, where the pet harness safety system comprises:
a harness assembly, comprising:
a first body loop;
a second body loop;
a front body support joining the first body loop and the second body loop;
a primary back plate to which the first body loop is secured; and
a secondary back plate to which the second body loop is secured, where the secondary back plate may removably attach to the primary back plate;
such that the body support may be placed on the animal's chest, the first body loop and the second body loop may each encircle one of the animal's shoulders, and the primary back plate may be connected to the secondary back plate such that both the primary back plate and the secondary back plate lie adjacent the animal's back; and
a carabiner tether assembly, comprising:
an elongate tether body with a first end and an opposing second end;
a first carabiner attached to the first end, where the first carabiner may be secured to the harness assembly; and
a second carabiner attached to the second end, where the second carabiner may be secured to an in-vehicle restraint system.

2. The pet harness safety system of claim 1 where the first body loop has a reinforced segment secured to the primary back plate such that the reinforced segment forms a first reinforced segment loop and the second body loop has a reinforced segment secured to the secondary back plate such that the reinforced segment forms a second reinforced segment loop, such that the first reinforced segment loop is adjacent the second reinforced segment loop when the primary back plate is removably attached to the secondary back plate.

3. The pet harness safety system of claim 2 where the first carabiner is secured to the harness assembly via the first reinforced segment loop and the second reinforced segment loop.

4. The pet harness safety system of claim 2 where the primary back plate comprises:
a first segment, where the first segment has a width where the first segment comprises an aperture having opposing enlarged ends separated by opposing projections; and
a second segment, where the second segment has a width greater than the width of the first segment and where the second segment has a fitting connector component that mates with a fitting connector component connected to the secondary back plate;
such that the secondary back plate may be connected to the primary back plate via the two fitting connector components, the first segment of the primary back plate may be folded over the second segment of the primary back plate, and the first reinforced segment loop and the second reinforced segment loop may be fed through the I-shaped aperture of the first segment of the primary back plate.

5. The pet harness safety system of claim 4 where the first segment may be removably connected to the second segment via a hook and loop fastener.

6. The pet harness safety system of claim 1 where the first body loop and the second body loop each have a slide such that the sizes of the first body loop and the second body loop may be independently adjusted.

7. The pet harness safety system of claim 1 where the body support comprises:
an upper section comprising two opposing flared members, each having a series of body loop apertures for receipt of the first body loop and the second body loop, respectively;
a lower section having a series of body loop apertures for receipt of the first body loop and the second body loop; and
an intermediate section joining the upper section and the lower section, where the intermediate section has a width less than a width of the lower section.

8. The pet harness safety system of claim 7 where the two opposing flared members of the upper section are joined by a substantially v-shaped webbing joint secured intermediate of the two opposing flared members, such that the body support is substantially y-shaped at the upper section

9. The pet harness safety system of claim 7, further comprising a substantially tubular wrap surrounding the intermediate section of the body support.
